(19) United States
(12) Patent Application Publication
(10) Pub. No.: US 2026/0261818 A1
(43) Pub. Date: Sep. 3, 2026

(54) SYSTEM AND METHOD FOR CONTROLLING THE SOUNDSTAGE RENDERED BY LOUDSPEAKERS

(71) Applicants: Tesla, lnc., Austin, TX (US); The Trustees of Princeton University, Princeton, NJ (US)

(72) Inventors: Edgar Choueiri, Princeton, NJ (US); Rahulram Sridhar, Watertown, MA (US); Joseph Tylka, Princeton, NJ (US); James R. Hall, Los Altos, CA (US)

(21) Appl. No.: 19/163,208

(22) PCT Filed: Mar. 5, 2024
(86) PCT No.: PCT/US2024/018518

§ 371 Date: Sep. 8, 2025

Related U.S. Application Data
(60) Provisional application No. 63/489,124, filed on Mar. 8, 2023.

(51) Int. Cl. H04S 7/00

(52) U.S. Cl. CPC H04S 7/305; H04S 7/303; H04S 2420/01

(57) ABSTRACT

The present disclosure relates to a method for designing a sound stage control (SSC) processor to control a sound stage rendered by distributed loudspeakers in acoustically reflective environments. The method includes step A, including designing of Alignment Stage filters, step B, including measuring the response from the different loudspeakers to the same control points with the Alignment Stage filters applied, step C including pre-processing of the response obtained in step B by time-windowing impulse responses in a frequency-dependent manner, a step D including inverting of pre-processed IRs obtained from the step C; and a step E including cascading of the Alignment Stage and SSC Stage to program the SSC processor.

### CROSS-REFERENCE TO RELATED APPLICATION

This application claims priority to U.S. Provisional Patent Application No. 63/489,124 titled “System and Method for Controlling the Soundstage Rendered by Loudspeakers Distributed Arbitrarily in a Reflective Environment” and filed on Mar. 8, 2023, the disclosure of which is hereby incorporated herein by reference in its entirety.

### BACKGROUND

### Field of the Invention

The present disclosure relates to a system and method for designing a sound stage control (SSC) processor to control the sound stage rendered by an array of distributed loudspeakers in acoustically reflective environments.

### Background

Without proper processing, audio rendered through multiple loudspeakers in a highly reflective environment, such as the interior of a car cabin, may result in a “soundstage” that is imprecise, often asymmetric, and where the sound has unfavorable tonal and temporal characteristics. As used herein, a “soundstage” generally refers to a spatial region perceived by one or more listeners, in which an audio system renders sound sources. An imprecise soundstage can be one where the listener is either unable to precisely localize rendered sound sources or, if the sound is clearly localizable, then its perceived location is not desirable from an aesthetic standpoint. An asymmetric soundstage can generally refer to a soundstage in which the left and right ends of the soundstage are perceived to be asymmetric with respect to the listener. Unfavorable tonal characteristics may be quantified as any departure from a target or desired frequency response (in magnitude and/or phase) as measured at any listening position.

Digital filters can be used to process the audio signals to control the soundstage rendered by loudspeakers. The basic principle is to use one or more digital filters to process the audio signal sent to each loudspeaker such that the acoustic responses measured at the ears of each listener match desired target responses. Such filters are termed soundstage control (SSC) filters. A major challenge is that filter performance suffers in the presence of reflections (the highly reflective environment of a car cabin is a typical example). Designing the filters to compensate for the reflections is possible in principle, but the soundstage and tonal characteristics of the sound reproduced with such filters will be highly sensitive to changes in listening position. Even slight deviations from the precise listening position will, in practice, change the arrival time of the reflections at the ears of the intended listener(s), and result in an unacceptable acoustic response at the ears and/or loss of sound stage control (SSC) performance. Although this can be addressed by updating filters dynamically (i.e., in real-time) based on tracking a listener's position using cameras and tracking software, the large variations in arrival times and levels of reflections will require 1) switching between many filters to cover a small range of listener movement or 2) frequent real-time filter updates. This not only increases the computation and implementation cost and complexity but, as we describe subsequently, makes it more challenging to effectively implement spatial audio techniques such as crosstalk-cancellation (for rendering 3-dimensional audio through only two channels) and real-time filter interpolation, due to the filter responses being smeared in time.

Another challenge arises when the loudspeakers are positioned asymmetrically relative to each listener and have limited operational bandwidths. This is common, for example, in a car cabin, where individual loudspeakers must be limited in size due to practical reasons such as limited mounting spaces and safety. As such, the distances from the tweeters to the listeners' ears can be significantly different from the distances of the midrange and low frequency drivers. This results in impulse responses (IRs) between individual loudspeakers and the listeners' ears that are less coherent in time. In other words, exciting a single channel (e.g., left channel of a stereo input) can result in IRs that are more smeared in time compared to those obtained from exciting a traditional stereo loudspeaker setup, for example, where, for each loudspeaker, all drivers (e.g., woofers and tweeters) are closely spaced (e.g., housed in the same cabinet). Such smeared IRs are not only harder to equalize (a necessary step for soundstage control) but result in soundstage control (SSC) filters that are themselves smeared in time, making it more challenging to implement advanced solutions such as crosstalk-cancellation (for rendering spatial audio through only two channels) and real-time filter interpolation for acoustic response compensation through head tracking to enhance performance robustness against head movements.

A problem in designing SSC filters is the choice of the time windows needed to include or exclude reflections. On one hand, long windows tend to include more reflections and therefore tend to have more late-time energy (i.e., the impulse response has more late-time excursions from zero), which leads to 1) higher latency; 2) more CPU and RAM requirements; 3) lack of robustness to head movements; and 4) requirement for more aggressive equalization to ensure acceptable sound outside the sweet spot, which leads to dynamic range loss. Also, long windows tend to decrease the perceived distance to the soundstage when using anechoic spatial target responses (e.g., HRTFs). As such, to control sound stage distance with longer windows, one would need room information (whether measured or modeled), which increases complexity and the possibility of other errors (e.g., increased processing requirements if using a room model implemented in real time, or lack of individualization if using a measured room response). On the other hand, short windows include less reflections and therefore tend to maintain perceived distance to the sound stage. However, short windows restrict the spectral control needed to meet the target spectral response, especially at low frequencies.

### SUMMARY

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing digital filter designs.

Embodiments of the invention relate to systems and methods for designing a soundstage control (SSC) processor that provides effective SSC in reflective environments while largely avoiding the many drawbacks discussed above. Such a SSC would also facilitate effective implementations of 1) existing crosstalk cancellation (which allows rendering spatial/3D audio through 2-channel signals and thus enhance the perceived depth of the soundstage), and 2) dynamic filtering using head tracking techniques. Embodiments also include SSC processors and vehicles comprising such processors.

Some embodiments include a method for designing a digital signal processor to control the spatial characteristics (depth, azimuthal extent, elevation, and symmetry) of the soundstage rendered by loudspeakers in an acoustically reflective environment, even if the loudspeakers are positioned non-uniformly in space and operate in different spectral bands—one such case is the array of speakers in a modern car cabin. By depth we refer herein to the perceived distance between a listener's head and the soundstage (perceived depth can also be enhanced by spatial audio rendering techniques, such as crosstalk cancellation). Embodiments can also be used to control multiple soundstages separately for multiple listeners in the same space (e.g., passengers in a car). Embodiments can also account for the movement of one or more listeners to ensure that the soundstage is stable in the presence of such movement.

In some embodiments, the method is made up of five general steps:
I) Designing a set of time-alignment and level-matching filters for the array of arbitrarily distributed loudspeakers, which constitutes the first stage (Alignment Stage) of signal processing.
II) Measuring the resulting response of the system at the ears of the listener(s) with the filters applied.
III) Pre-processing the measured (or simulated) responses of the Alignment Stage filters by time-windowing the reflections in a frequency-dependent manner that leverages the effects of reflections to provide effective control of the perceived soundstage depth.
IV) Using the pre-processed responses of the Alignment filters with a spatial target response (either a head-related transfer function (HRTF) or a measured acoustic response) to design the second stage (SSC) filters through regularized least-squares pseudoinversion.
V) Cascading the filters from the two stages (after optional equalization of the SSC filters) to yield the ultimate SSC processor, which allows effective control of the soundstage's depth, azimuthal spread, symmetry, and elevation.

In some embodiments, the method comprises two additional steps:
I) Designing a bank of ultimate SSC processors for a discrete set of listener head positions (including position combinations in the case of more than one listener).
II) Using cameras and tracking software to track the movements of one or more listener heads and dynamically (i.e., in real-time) updating the active ultimate SSC processor by interpolating between two or more processors from the bank based on head tracking data.

One element of the aforementioned method is the frequency-dependent time windowing of reflections (which can be done equivalently using complex smoothing) in Step III, which can enable the direct sound, early reflections, and low-frequency components of later reflections (responsible for easily controllable room modes) to be compensated while leveraging the high-frequency components of later reflections, which are harder to equalize and more sensitive to listener position, to control soundstage distance. This windowing step also allows the simultaneous enablement of anechoic spatial targets, such as HRTFs, and having soundstage distance control. Without such windowing, distance control can only be achieved with spatial targets that also contain a room response and could suffer from many of the drawbacks mentioned above with the prior art. Furthermore, SSC filters designed based on the Alignment Stage in Step I and the windowed responses in Step III are more compact in time, enabling their interpolation to be carried out more accurately and efficiently in real-time, which is a key step in dynamically updating the filters based on head position through head tracking.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects.

One aspect is a method for programming a sound stage control (SSC) processor to control a sound stage rendered by an array of arbitrarily distributed loudspeakers in acoustically reflective environments. This method may include the steps of: designing alignment stage filters to obtain time-aligned and level-matched responses from different loudspeakers as measured at specific control points in the environment; (b) measuring a response from the different loudspeakers to the same control points with the alignment stage filters applied; (c) pre-processing, the response by time-windowing impulse responses in a frequency-dependent manner, so that one or more of direct sound, early reflections, and low-frequency components of later reflections are compensated for, while high-frequency components of later reflections are left out of the compensation; (d) inverting pre-processed IRs obtained from step (c) using regularized pseudoinversion and cascading with spatial target responses to obtain the filters for a SSC stage; and (e) cascading of the alignment stage and SSC stage to program an SSC processor. Some embodiments include a sound stage control processor programmed by any of the above methods.

### BRIEF DESCRIPTION OF THE DRAWINGS

FIG. 1A illustrates one application of an SSC processor, providing an improved soundstage for two listeners in an acoustically reflective environment using an array of loudspeakers typical of a car cabin.

FIG. 1B an example flow diagram of process to design SSC digital filters.

FIG. 2 is a flowchart depicting one example of a general signal flow that includes Alignment Stage and SSC Stage filters that comprise an embodiment of a soundstage control filter.

FIG. 3 is flowchart depicting one example of a design method for the Alignment Stage filters.

FIG. 4 is a flowchart depicting one example of a design method for the SSC Stage filters.

FIG. 5 is a flowchart depicting one example of the sub-steps involved in carrying out step 32 in FIG. 4.

FIG. 6 is a flowchart depicting one example of the sub-steps involved in carrying out step 34 in FIG. 4.

FIG. 7 is a flowchart depicting one example of the sub-steps involved in carrying out step 36 in FIG. 4.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals and/or terms can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

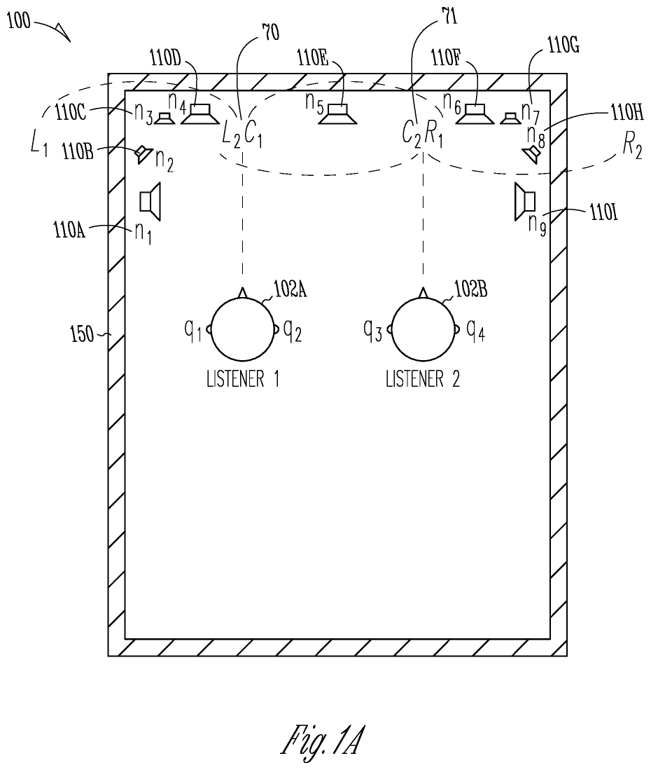

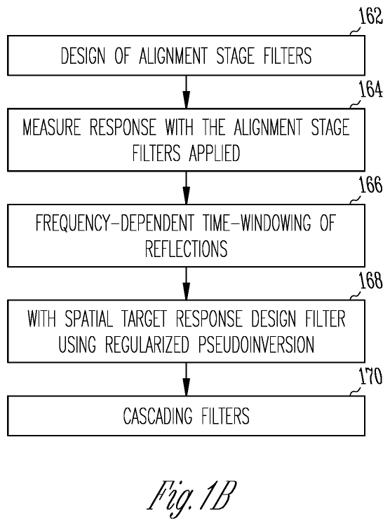

Embodiments of the invention relate to sound stage control (SSC) processors and related methods for designing digital filters implemented in such processors for processing sound, particularly in a vehicle embodiment. For example, the method may include the five steps mentioned in detail below, which result in the design of two stages of digital filters that combine to yield an SSC processor that provides effective spatial control of a soundstage for multiple listeners in an acoustically reflective environment using an arbitrary distributed array of loudspeakers 110A-110I (see, FIG. 1A). FIG. 1A illustrates an application where each listener 102A, 102B perceives a soundstage comprising of Left (L), Center (C), Right (R) images from an array of N loudspeakers 110A-110I in a car cabin. Listener 1 102A perceives soundstage L₁, C₁, R₁ (70) while Listener 2 102B perceives soundstage L₂, C₂, R₂ (71). As described below, the process of designing the filters could use fewer or more individual steps, or combine certain steps together, without departing from the spirit of the invention.

FIG. 1B illustrates a flow diagram of a process of designing digital filters. The process of designing digital filters, as disclosed herein, can include 5 steps, as illustrated in FIG. 1B. These steps are illustrated as examples, and fewer or more individual steps can be used for designing the digital filters, or one or more steps can be combined based on specific applications. In the present disclosure, Roman numerals are used to denote the five general steps of the method, and Arabic numerals are used to denote detailed steps, some of which are either optional, or can be implemented differently in different embodiments of the method described below.
Step I (162): Design of Alignment Stage filters: The Alignment Stage filters may be linear-phase bandpass filters (one per loudspeaker 110A-110I) with pre-determined passbands where the passband gains and group delays are set such that all loudspeakers 110A-110I to the left and right of all listeners 102A, 102B result in acoustic responses that have the same overall delay and average level when measured at the left/right ear of the leftmost/rightmost listener 102A/102B, respectively. For all other loudspeakers that are not to the left and right of the listeners 102A, 102B, the gains and delays are set such that acoustic responses have the same overall delay and average levels when further averaged across measurements made at all listeners' ears that are closest to each loudspeaker 110A-110I. In all cases, each listener is assumed to occupy a pre-determined nominal listening position. For example, in a vehicle, the listeners are assumed to occupy the front seats.
Step II (164): Measuring the Response with the Alignment Stage Filters Applied: This step II (164) includes measuring the transfer function between the different loudspeakers and the same control points (typically located at each of the listener's ears) used in Step I (162) but with the Alignment Stage filters applied.
Step III (166): Frequency-Dependent Time-Windowing of Reflections: In this Step III (166), the impulse responses obtained from Step II (164) are processed by time-windowing the reflections in a frequency-dependent manner, or equivalently by using a method such as complex fractional-octave smoothing (CFOS). This part of the method allows early components (such as direct sound, early reflections) to be compensated but later components can be progressively low-pass filtered leaving the higher-frequencies (which are harder to equalize and more sensitive to a listener's position) out of the compensation.
Step IV (168): With Spatial Target Response Design Filter using Regularized Pseudoinversion: The SSC Stage filters are then computed, using the impulse responses obtained from Step III, through a regularized least-squares approach, where a spatial target response is specified to either be a head-related transfer function (HRTF) or a measured acoustic response and may additionally have constraints applied on the cross paths. The SSC Stage filters are subsequently post-processed by applying either minimum or linear-phase equalization filters to ensure that the response corresponding to a mono input (or a stereo input with perfectly correlated left and right channels or the center channel of a multi-channel input) matches a target spectral response.
Step V (170) Cascading Filters: The overall SSC signal processor is then implemented as a cascade of the Alignment Stage filters and SSC Stage filters described above.
Step I (162), is used to make the final SSC Stage filters more compact in time. Step III (166) allows effective control of the perceived depth of the soundstage while maintaining time-compactness. The spatial target introduced in Step IV (168) allows controlling the perceived width, symmetry, and elevation of the soundstage, while the regularized optimization in that step ensures maximizing SSC performance with minimal coloration, leading to an SSC processor that is largely immune to the drawbacks listed above with the prior art.

In some embodiments, the above five steps (162-170) are repeated for various positions of each of the listener's heads to create a bank of the cascaded filters described in Step V (170). Real-time linear interpolation is then used to smoothly change the filters based on listener head movements tracked through any head tracking technique, although any other form of interpolation may also be used. In place of interpolating between a bank of filters, a single set of cascaded filters may be updated in real-time without departing from the spirit of the invention.

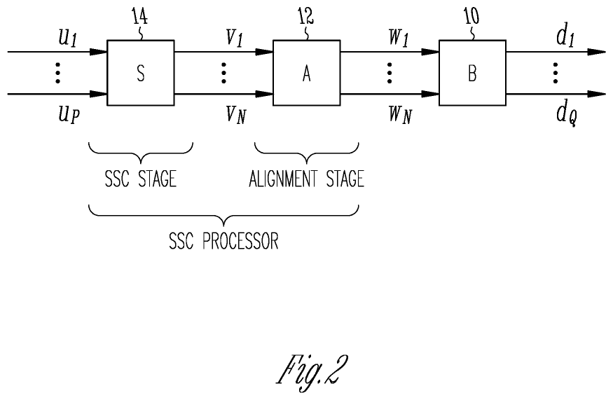

One embodiment of a method of the invention is depicted in the SSC processor illustrated in FIG. 2. In step 10, the acoustic responses between each of N loudspeakers and Q control points (e.g., the ear canal entrances of each listener) are measured. These responses are represented in the frequency domain as a Q×N transfer function (TF) matrix B. The measurements are performed using, for instance, exponential sine sweeps as described by Joseph G. Tylka, Rahulram Sridhar, Braxton B. Boren, and Edgar Y. Choueiri in the article “A new approach to impulse response measurements at high sampling rates” presented at the 137th Audio Engineering Society Convention, 2014, and in the U.S. Pat. No. 9,959,883. The matrix, B, is then used to calculate the Alignment Stage filters in step 12, represented by the N×N filter matrix, A. Finally, the overall responses of A cascaded with B, which may be determined either by measurement or simulations, are used along with pre-determined target responses, to calculate the SSC stage filters in step 14, represented by the N×P filter matrix, S. The overall SSC processor is then implemented as the cascade of filter matrices S and A and is, therefore, an N×P filter matrix, where P is the number of input channels (e.g., P=2 for a stereo input).

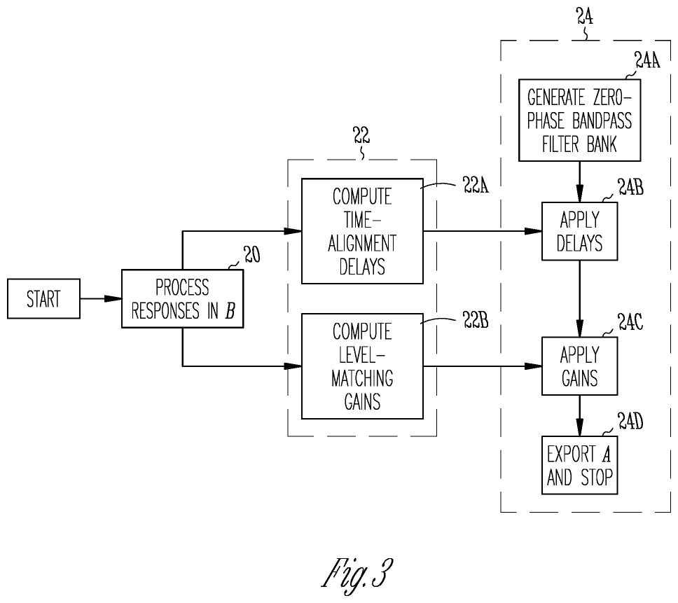

To compute the filter matrix, A, the first step involves processing the transfer functions (TFs) in B, as shown in step 20 in FIG. 3. More specifically, the corresponding IRs (which are typically computed from B via the inverse fast Fourier transform) are windowed in time (typically, using a raised-cosine window) and then grouped according to the position of each loudspeaker relative to all listeners. The grouping of loudspeakers is performed such that all loudspeakers to the left/right of all listeners belong to their own groups (one each for left and right), while all other loudspeakers are grouped according to their proximity to individual control points, which is application-specific (i.e., depends on the number and relative positioning of loudspeakers and control points).

Delays and gains for time-aligning and level-matching responses both within and across groups are then computed in step 22, with the goal of normalizing the average level and onset of each loudspeaker IR as measured at appropriately chosen control points. For example, step 22 can include computing time-alignment delays 22A and computing level-matching gains 22B. This is done so that IRs between individual loudspeakers and the listeners' ears are, on average, more coherent in time, and is a critical step to achieving soundstage control filters that have a more compact time-domain response. Such a response is desirable because it enables, for example, better-performing crosstalk-cancellation filters (for rendering spatial audio using only two channels).

The delays are calculated based, for instance, on IR onsets estimated as the first instance where the absolute magnitude of an IR exceeds 20 percent of its absolute peak magnitude (the so-called “IR thresholding method”), although any other technique for extracting or estimating the delay may be used. For example, the absolute magnitude of the IR may exceed 10%, 15%, 20%, 25%, 30% or more of its absolute peak magnitude and still be within the spirit of the invention. The gains are calculated as linear averages of the response magnitudes within pre-determined passbands of the loudspeakers, although any other equivalent metric may be used.

From the computed passband gains and group delays of individual loudspeakers, level-matching gains and time-alignment delays are computed. Typically, these gains and delays are applied such that resulting acoustic responses for all loudspeakers to the left/right of all listeners have the same (or close to the same) overall delay and average level when measured at the left/right ear of the leftmost/rightmost listener, respectively. For all other loudspeakers, the gains and delays are applied such that acoustic responses have the same (or close to the same) overall delay and average levels when further averaged across measurements made at the right/left cars of the leftmost/rightmost listener, respectively. Finally, as shown in step 24, the computed gains and delays are applied (in apply delays 24B and apply gains 24C) to zero-phase bandpass filters (24A) to generate the desired Alignment Stage filter matrix, A (24D). In all cases, each listener is assumed to occupy a pre-determined nominal listening position. However, alternative groupings of loudspeakers, positioning of listeners, and application of gains and delays may be possible.

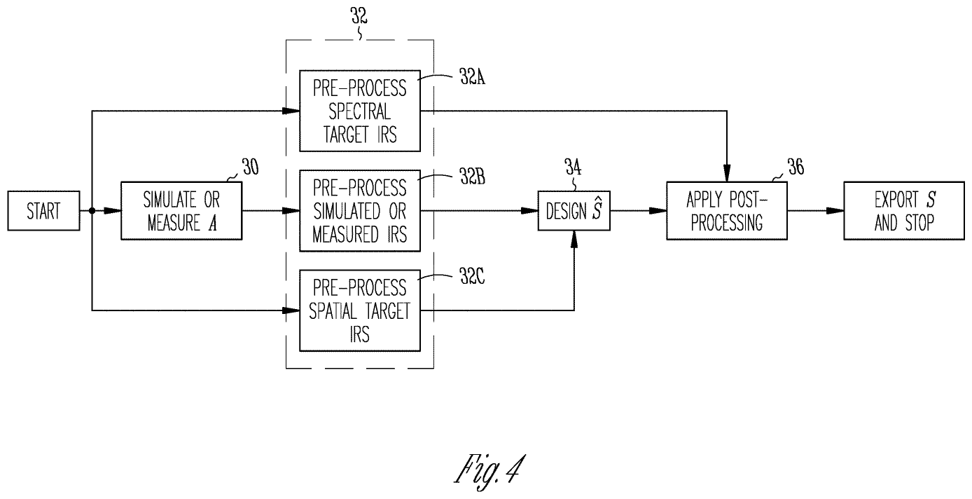

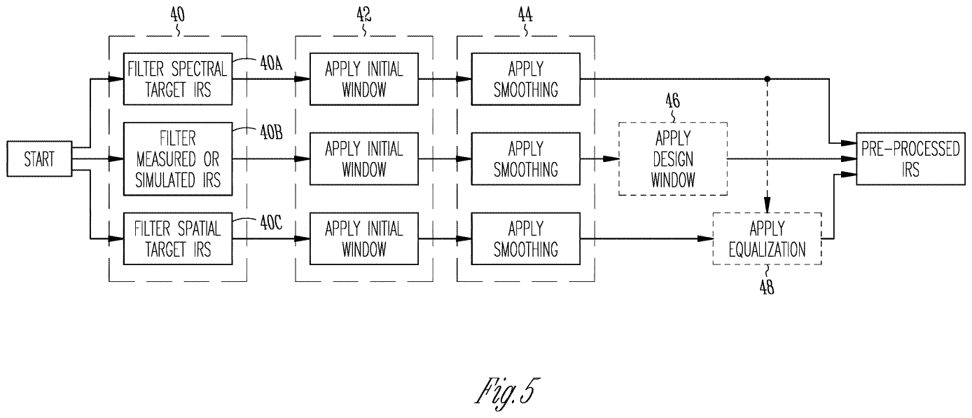

To compute the filter matrix, S, the first step involves measuring, or simulating, the response with the Alignment Stage filters applied. This is depicted as step 30 in FIG. 4, where a measurement of A involves performing an acoustic measurement as described earlier, this time with the filters in A included in the signal chain, whereas a simulation of A involves convolving (in the time-domain) the filters in A with the responses in B. As described in step 32 in FIG. 4, these responses are then pre-processed, along with the responses corresponding to chosen spectral and spatial targets. For example, step 32 can include pre-processing spectral target IRs 32A, simulation or measured IRs 32B, and spatial Target IRs 32C. The pre-processing in this step consists of multiple sub-steps shown in FIG. 5.

A typical example of the first two of these sub-steps involves applying a bandpass filter with a passband of 30 Hz to 18 kHz (see step 40, for example filter spectral target IRs 40A, filter measured or simulated IRs 40B, and filter spatial target IRs 40C) followed by an initial Tukey window with a length of approximately 341 ms (see step 42). This filtering and windowing are used for performing the subsequent complex smoothing operation shown as step 44. The filtering enables a more accurate estimation of IR onsets using the thresholding approach described earlier (for the operations performed as part of step 22 shown in FIG. 3) to remove any overall delay in the IRs, which is one step used prior to complex fractional-octave smoothing according to Panagiotis D. Hatziantoniou and John N. Mourjopoulos in their paper titled “Generalized fractional-octave smoothing of audio and acoustic responses” published in Volume 48, Issue 4 of the Journal of the Audio Engineering Society in April 2000. The windowing is performed to reduce smoothing computation time.

The complex smoothing implemented in step 44 is an improved version over the one described in the paper by Hatziantoniou and Mourjopoulos in that it preserves log-frequency symmetry. The preservation of log-frequency symmetry is achieved using the algorithm described by Joseph G. Tylka, Braxton B. Boren, and Edgar Y. Choueiri in their paper titled “A Generalized Method for Fractional-Octave Smoothing of Transfer Functions that Preserves Log-Frequency Symmetry” published in Volume 65, Issue 3 of the Journal of the Audio Engineering Society in March 2017.

As described by Hatziantoniou and Mourjopoulos in their paper, complex smoothing (performed in the frequency domain) has the time-domain effect of gradually windowing out later reflections, with a stronger emphasis on the higher frequency components of these reflections. The greater the amount of smoothing, the more pronounced is the windowing effect. As an alternative or a supplement to smoothing, an additional design window may be optionally applied to the measured or simulated Alignment Stage response. This is step 46 in FIG. 5 and is depicted by the dotted block to indicate that it is an optional step.

One aspect of the present invention is the ability of the filter designer to control the extent of complex smoothing/optional windowing applied which has a direct effect on the perceived depth of the soundstage. This is because by increasing smoothing or applying the optional design window, some of the reflections in the simulated or measured Alignment Stage response are removed and thus, as described subsequently, are left uncompensated in the design of the SSC Stage filters. As such, instead of the typical approach of attempting to fully compensate for the reflections (i.e., perform room response equalization), the method of the present invention leverages some of these reflections, in a frequency-dependent manner, to help control soundstage depth. An advantage of CFOS is that the reflections are partially compensated in a frequency-dependent manner, allowing the direct sound, early reflections, and low-frequency components of later reflections (responsible for more easily controllable room modes) to be compensated while leveraging the high-frequency components of later reflections, which are harder to equalize and more sensitive to listener position, to control soundstage depth. It is important to note that CFOS is equivalent to using multiple time-windows each operating in a different frequency band, and that this step of the invention can be implemented using either method or another equivalent one.

Step 48 in FIG. 5 is another optional step and involves applying either a minimum-phase or linear-phase equalization filter to the spatial target IRs. The equalization filter is designed to equalize either the magnitude response of each individual spatial target or an average response computed from one or more individual responses to the corresponding magnitude response of the spectral target. This step is optional because the equalization to the spectral target can alternatively be performed exclusively as part of step 36 shown in FIG. 4.

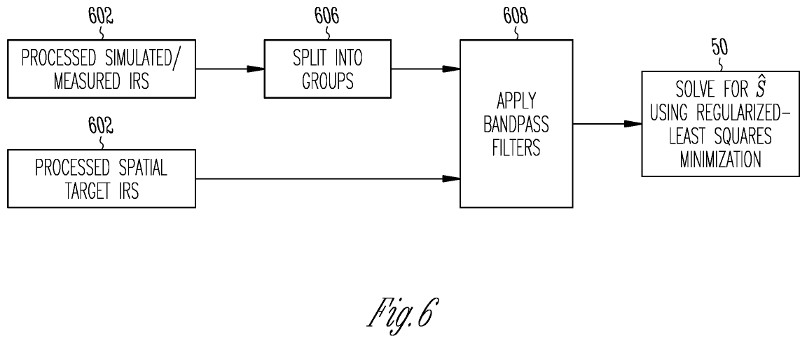

Returning to FIG. 4, once all IRs have been pre-processed in step 32, intermediate SSC Stage filters are designed in step 34. This is depicted in FIG. 6, where the simulated/measured IRs after processing 602 are split into groups 606 and further filtered 608 according to their pre-determined usable passbands. The same filters are also applied to the spatial target IRs (e.g., processed spatial target IRs 604), following which an intermediate SSC Stage filter matrix is designed for each group using a regularized least squares minimization approach. Once the SSC Stage filter matrix for each group is computed, these filters are combined into a single SSC Stage filter via the application of appropriately chosen Linkwitz-Riley crossover filters.

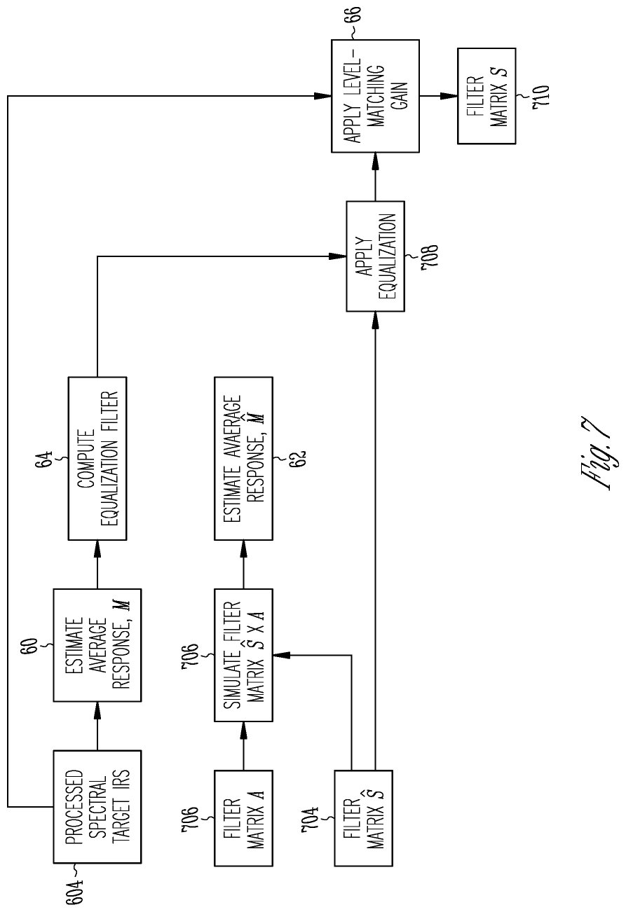

The final step in the design of the SSC Stage filters is post-processing the intermediate filters as depicted in FIG. 4, step 36. FIG. 7 shows a flowchart of the post-processing sub-steps applied to these filters. In step 60, an average response, M, is estimated from the processed spectral target IRs 604 (using the processing shown in FIG. 5) that represents the response perceived by all listeners to a mono input (or a stereo input with perfectly correlated left and right channels or the center channel of a multi-channel input). The same is done in step 62, this time starting with a simulation or acoustic measurement of the overall response with the Alignment Stage and intermediate SSC Stage filters applied in cascade. For example, the Alignment Stage filter matrix A 702 and intermediate SSC Stage filter matrix 704 are applied in cascade and simulated in step 706. Both these average responses are then used in step 64 to compute an equalization filter. The equalization filter is computed by first inverting the average response, \hat{M}, with frequency-dependent regularization applied, and cascading the resulting inverse filter with the average response, M. A minimum-or linear-phase version of the equalization filter is then applied (at step 708) to the intermediate SSC Stage filter matrix 704. These steps allow the response of the SSC Stage filters to be compensated with minimal to no effect on the perceived spatial characteristics of the soundstage. In step 66, a level-matching gain is applied to ensure that toggling the SSC Stage filters on or off does not cause an appreciable change in perceived overall loudness of the reproduced audio. The SSC stage filter matrix 710 is generated at step 710. This level-matching gain is computed by using the loudness-based binaural model described by Ville Pulkki, Matti Karjalainen, and Jyri Huopaniemi in their paper titled “Analyzing Virtual Sound Source Attributes Using a Binaural Auditory Model” published in Volume 47, Issue 4 of the Journal of the Audio Engineering Society, to estimate the perceived loudness with and without the SSC Stage filters applied, and essentially computing the ratio of these quantities.

Finally, the Alignment Stage and SSC Stage filters are cascaded to produce the desired SSC processor. This SSC processor may, for example, be incorporated into a vehicle to provide a sound stage with improved performance. Furthermore, the incorporation can be in the form of a single SSC processor that is either static or dynamically updated (whether it be through interpolation from a bank of SSC processors or otherwise) based on tracking data representing the instantaneous head positions of the listeners.

In the foregoing specification, the disclosure has been described with reference to specific embodiments. It will, however, be evident that various modifications and changes may be made thereto without departing from the broader spirit and scope of the disclosure. The specification and drawings are, accordingly, to be regarded in an illustrative rather than restrictive sense.

Indeed, although this disclosure is in the context of certain embodiments and examples, it will be understood by those skilled in the art that the inventions extend beyond the specifically disclosed embodiments to other alternative embodiments and/or uses of the inventions and equivalents thereof. In addition, while several variations of the embodiments have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments disclosed herein. Any methods disclosed herein need not be performed in the order recited. Thus, it is intended that the scope of the disclosure should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the disclosure is not to be limited to the particular forms or methods disclosed, but, to the contrary, the disclosure is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions, including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

What is claimed is:

1. A method for programming a sound stage control (SSC) processor to control a sound stage rendered by an array of arbitrarily distributed loudspeakers in acoustically reflective environments, said method comprising the steps of:
(a) designing alignment stage filters to obtain time-aligned and level-matched responses from different loudspeakers as measured at specific control points in the environment;
(b) measuring a response from the different loudspeakers to same control points with the alignment stage filters applied;
(c) pre-processing the response by time-windowing impulse responses in a frequency-dependent manner, so that one or more of direct sound, early reflections, and low-frequency components of later reflections are compensated for, while high-frequency components of later reflections are left out of the compensation;
(d) inverting pre-processed IRs obtained from step (c) using regularized pseudoinversion and cascading with spatial target responses to obtain the filters for a SSC stage; and
(e) cascading of the alignment stage and SSC stage to program an SSC processor.

2. The method of claim 1, where the alignment stage filters in step (a) are obtained using a measured transfer function.

3. The method of claim 1, where the alignment stage filters in step (a) are obtained using a calculated or numerically simulated transfer function.

4. The method of claim 1, where the alignment stage filters in step (a) are based on measurements of sound pressure levels and delays.

5. The method of claim 1, where the alignment stage filters in step (a) are modified by acoustic measurement.

6. The method of claim 1, where the response measured in step (b) is obtained from calculation or numerical simulation.

7. The method of claim 1, where the pre-processing in step (c) comprises complex fractional-octave smoothing.

8. The method of claim 1, where the pre-processing in step (c) comprises applying different time-windows applied to various frequency bands.

9. The method of claim 1, where the spatial target responses used in step (d) are measured or calculated using a head-related transfer function (HRTF) of a human or a dummy head.

10. The method of claim 1, where the spatial target responses used in step (d) are measured or calculated acoustic responses.

11. The method of claim 1, where the regularized pseudoinversion in step (d) is constant.

12. The method of claim 1, where the regularized pseudoinversion in step (d) is frequency dependent.

13. The method of claim 1, where the SSC processor in step (e) is programmed through a single stage of filters obtained by convolving the alignment stage filters with SSC Stage filters.

14. The method of claim 1, where the SSC processor in step (e) is progammed by cascading a signal through the alignment stage and the SSC stage in series.

15. The method of claim 1, where the SSC processor in step (e) is part of a CPU, GPU, DSP, or FPGA, or a network of such devices.

16. The method of claim 1, where the SSC processor in step (e) is implemented as software running on a computational cloud.

17. The method of claim 1, where the SSC processor in step (e) is implemented as one or more analog circuits, or a combination of digital and analog circuits.

18. The method of claim 1, wherein the method is repeated for different head positions to synthesize a bank of one or more filters based on the different positions of each listener's head.

19. The method of claim 18, where the one or more filters are synthesized by interpolation between filters in the bank.

20. The method of claim 18, where the different positions of each listener's head is determined using cameras and head tracking software.

21. The method of claim 18, where the different positions of each listener's head is determined acoustically.

22. A sound stage control processor programmed by the method of claim 1.

23. A sound stage control processor programmed by the method of claim 18.
